(19) United States
(12) Patent Application Publication
(10) Pub. No.: US 2024/0289873 A1
(43) Pub. Date: Aug. 29, 2024

(54) REINFORCEMENT LEARNING FOR AUTOMATED ALLOCATION OF RESOURCES TO SUB-CAMPAIGNS OF A CONTENT CAMPAIGN

(71) Applicant: Maplebear Inc. (dba Instacart), San Francisco, CA (US)

(72) Inventors: Chakshu Ahuja, San Jose, CA (US); Ramasubramanian Balasubramanian, Jersey City, NJ (US); Karuna Ahuja, San Francisco, CA (US)

(21) Appl. No.: 18/113,562

(22) Filed: Feb. 23, 2023

(51) Int. Cl. G06Q 30/08; G06N 20/00; G06Q 30/0601

(52) U.S. Cl. CPC G06Q 30/08; G06N 20/00; G06Q 30/0613

(57) ABSTRACT

An online system manages campaign participation by a plurality of sub-campaigns with a reinforcement learning model. The reinforcement learning model determines a current context and determines an action that affects the participation of the individual sub-campaigns. The reinforcement learning model may thus dynamically control the participation over time as different objectives are achieved by the sub-campaigns and may account for the different contexts that change over time.

### BACKGROUND

This disclosure relates generally to managing sub-campaigns for a content campaign. An online concierge system is an online system by which users can order items to be provided to them. As users interact with the online system, they may navigate a number of user interface elements, such as accessing a front page, searching for relevant items with a search query, navigating to categories of items, individual item pages, and so forth. When information is presented to the user (e.g., in response to the search query or items in a selected category), the interface on which the information is presented may include a user interface element in which additional information may be selected that is prioritized by the online concierge system. The user interface element may thus represent a “position” or “slot” in which the additional information may be provided. Many different items may be eligible for prioritization according to different content campaigns that each promote an item with promoted content (i.e., the information that may be placed in the available user interface element). To evaluate the relative importance of the different content campaigns in promoting the respective items, the online concierge system may perform an auction based on a bid provided by each content campaign. When a content campaign wins the auction, the respective promoted content of that content campaign is placed in the available slot to promote the item associated with the content campaign, and a cost for winning the auction is applied to reduce the available resources (such as budget) that are usable for the content campaign.

In many cases, the different situations in which user interface elements may be presented to a user represent different types or modalities for the content campaigns. For example, different auctions may be performed based on a keyword-based search (e.g., when a user enters keywords for a search query), a category-based search (a user views a particular item category), or when a user views a particular item (a user views a detailed information page about an item to add to a user's cart for purchase). Traditionally, each of these types of auctions may have different content campaigns. As such, to promote a particular item across these different auction types, a sponsor may create separate content campaigns for each auction type along with separate budgets for each. This can cause a mismatch when the relative effectiveness of the auction types for the item differs and particularly when the effectiveness may change in different contexts. This may mean that when a total overall budget is improperly allocated to less-effective campaigns or that when the effectiveness of the campaigns changes in different contexts, there is no effective way to adjust the allocation across types.

### SUMMARY

In accordance with one or more aspects of the disclosure, a content campaign is designed to include sub-campaigns corresponding to different auction types. The different auction types may correspond to different contexts in which promoted content appears, such as keyword-, category-, or product-based contexts. Rather than separately managing campaigns for each type with static budgets and bidding processes, the content campaign includes an overall budget that is allocated to the different sub-campaigns. The actual performance of each sub-campaign relative to a target objective of the campaign may differ from one another and may differ over time and for different contexts in which auction opportunities arise. The allocation of campaign budget to the different sub-campaigns is managed by a reinforcement learning model that determines how the different sub-campaigns compete in eligible auction opportunities (e.g., by managing the allocated budget to each sub-campaign, target spend rate, holdout rate, or determining whether to participate in particular auction opportunities).

The allocation of the campaign budget to the different sub-campaigns may also be optimized for the target objective within a period for the campaign. In general, as additional budget is allocated to a sub-campaign, that sub-campaign may compete in additional auctions (e.g., reduce a holdout rate) or increase a bid (i.e., increasing the frequency that the sub-campaign wins auctions). When one sub-campaign performs relatively well with respect to the target objective, it may not be effective while maximizing the target objective with the budget in the period to simply continue to increase the budget to that sub-campaign. First, the available information for the sub-campaign may err, such that other sub-campaigns may be revealed to perform better with additional information or under different conditions. Second, the sub-campaign (at a given bid value) may participate in every auction but may reach a limit on its spending rate given the available auction opportunities and other competing content campaigns. Third, when the amount to bid is dynamic (i.e., may be increased or decreased), the bid should not be increased beyond a value of the target objective (e.g., a bid that costs more for an expected value of winning the auction lower than the bid). As such, the budget should be allocated to other sub-campaigns to effectively achieve a desired spending amount (e.g., the total budget) within the period and to continue to gather information about the efficacy of other sub-campaigns. The reinforcement learning model monitors performance and spending of the respective sub-campaigns and adjusts the allocation accordingly, thus enabling optimized allocation over time.

The reinforcement learning model may adjust the participation of the sub-campaigns (i.e., the allocated budgets) at different intervals in the period (e.g., each hour of a 24 h campaign period), and in some embodiments may monitor and control bidding of different sub-campaigns for individual auction opportunities, using the context of the auction opportunity to evaluate whether the auction opportunity is relatively good or bad for a content campaign. In further embodiments, the online system may automatically generate parameters for the content sub-campaigns, enabling a sponsor to provide information about the content campaign, such as the promoted item, campaign content, budget, and campaign budget, and enabling the system to automatically generate parameters such as a bid and eligibility conditions (e.g., a description of the auctions for which the sub-campaign will compete, such as particular keywords of interest for a keyword campaign). This system also thus may automate the generation and execution of a content campaign for multiple auction types and optimize use of the budget for the multiple auction types with significantly reduced sponsor involvement or management.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online platform, such as a shopping concierge system, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a timing diagram for providing sponsored content to a user with sub-campaign management, according to one or more embodiments.

FIG. 6 is a block diagram showing dynamic management of sub-campaigns of a content campaign, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

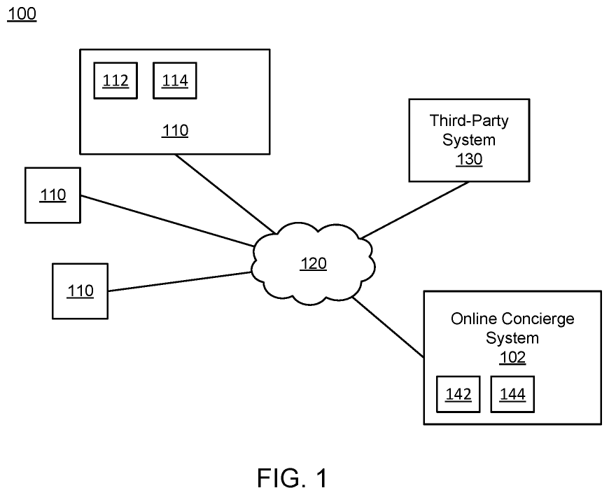

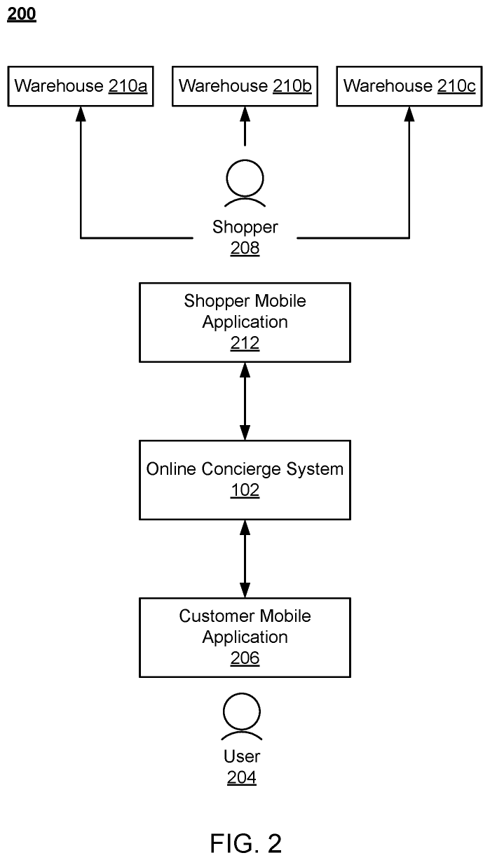

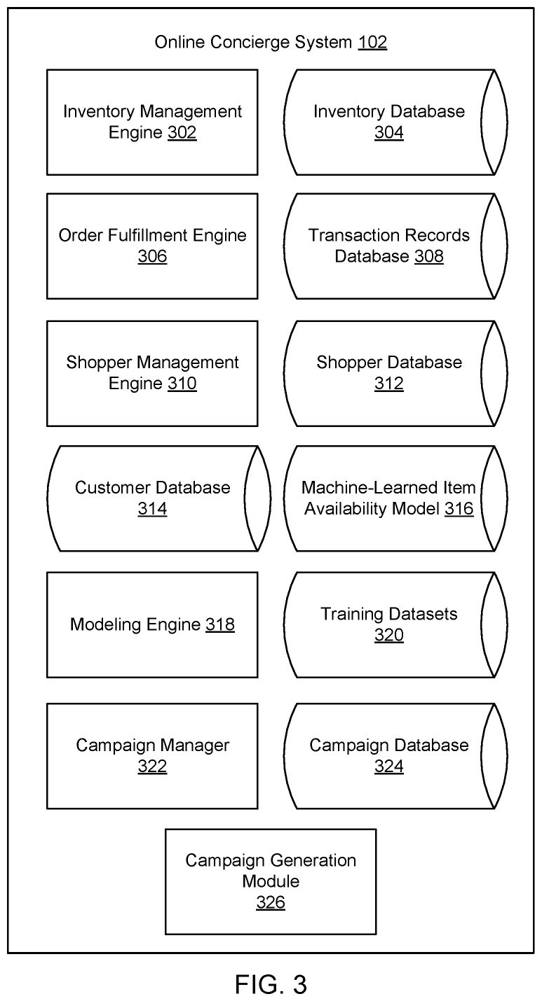

FIG. 1 is a block diagram of a system environment 100 in which an online system, such as an online concierge system 102 as further described below in conjunction with FIGS. 2 and 3, operates, according to one or more embodiments. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

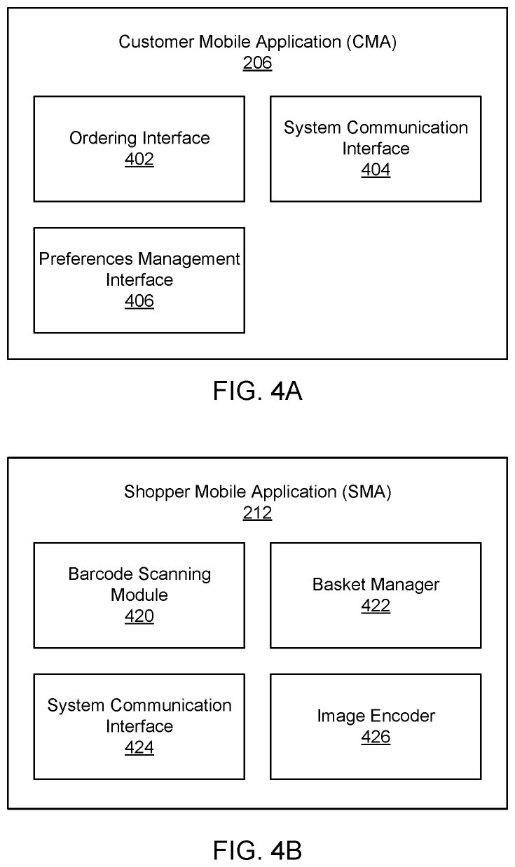

The client devices 110 are one or more computing devices capable of receiving user input as well as transmitting and/or receiving data via the network 120. In one or more embodiments, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one or more embodiments, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one or more embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102 or with the one or more client devices 110. In one or more embodiments, a third-party system 130 is an application provider communicating information describing applications for execution by a client device 110 or communicating data to client devices 110 for use by an application executing on the client device. In other embodiments, a third-party system 130 provides content or other information for presentation via a client device 110. For example, the third-party system 130 stores one or more web pages and transmits the web pages to a client device 110 or to the online concierge system 102. The third-party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described below. For example, the memory 144 has instructions encoded thereon that, when executed by the processor 142, cause the processor 142 to manage content sub-campaigns as discussed below. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third-party system 130, or the online concierge system 102 may be special purpose computing devices configured to perform specific functions, as further described below, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one or more embodiments, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one or more embodiments, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, stock keeping unit (SKU), serial number, and so on. In one or more embodiments, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210 different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one or more embodiments, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 206. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one or more embodiments, the order fulfillment engine 306 pushes transaction and/or order details asynchronously to retailer systems. This may be accomplished via the use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one or more embodiments, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more orders received after the received order and during the time interval, the one or more batches are also displayed to one or more shoppers 208 via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Promoted Content

The order fulfillment engine 306 may select and provide user interface elements and other components to be displayed to users and shoppers. As discussed above, users may interact with elements for selecting items to be included as part of an order. The order fulfillment engine 306 may select items to be presented to the user based on various factors and attributes, such as items searched for by a user, items related to items searched for by the user, items related to items in a user's order (e.g., a user's current cart), among other factors. In some instances, items may be presented to users based on content campaigns in which the relative prioritization of items may be affected by a budget and/or bid content campaign.

As the display space on a user's device is limited, the budget for each content campaign may be used as a mechanism to automatically allow the respective campaigns to compete for selection in the display space for the respective content of the campaign. Stated another way, selection of one campaign's content typically prevents selection of another campaign's content, such that the prioritization of presenting one campaign content thus naturally “competes” with prioritization of presenting another's. The campaigns may be associated with items of interest to the user, such as individual items that may be added to a user's order, or may be other types of content or information that may be of value to present to the user and thus compete for limited space on the user's display. Thus, the items with respect to content presented in a content campaign may include items that may be added to an order and may also relate to other information or content that is not a direct presentation of an item offered as part of an order, such as other supplemental information or information that may be beneficial for a user. As examples, items for prioritization with the content campaigns may include informational items related to additional features or aspects of the online concierge system (e.g., information for assisting new users in navigating the system, suggestions for a user to try additional features or aspects, “how-to” informational tips for the online system, offers for a user to subscribe to additional optional features, etc.), suggested uses or complementary items for items in a user's cart (e.g., for food items, suggested recipes or food/drink pairings), and so forth.

The items may compete by offering a portion of the presentation budget (e.g., a bid) that may compete with portions of other budgets, such that the content campaign offering the highest value may reflect the highest prioritization for an item to be presented. For convenience, the portion offered by a campaign is referred to as a “bid.” However, the budget may not represent real currency and may represent other priorities competing for limited area on a user's display such as the examples above. In some circumstances, the content campaigns may include sponsored content, such that the bid represents a value from a promoter of a particular item for presenting that item to the user; in other circumstances, the items may represent the prioritization of items beneficial to effective operations of the system, warehouses, items of interest to users (e.g., suggested items to complement existing items), based on excess warehouse stock, etc.

The online concierge system 102 may perform an auction to select a winning content campaign based on the various bids of the competing content campaigns. In some embodiments, the items may be selected based on a second-price auction. When a particular content campaign wins the auction, a portion of the content campaign budget is used and the promoted content associated with the content campaign is presented to the user. Different content campaigns may also be eligible to be provided to different users and orders based on various criteria, such as the warehouse fulfilling the order, items in the user's cart, the user's historical purchases, etc.

The content campaigns may be stored in a campaign database 324. The campaign database 324 may include currently active content campaigns along with historical data regarding performance of previous content campaigns.

As the user interacts with the online concierge system 102 (e.g., through user interface displays such as ordering interfaces or search interfaces provided by the order fulfillment engine 306), the online concierge system 102 (e.g., as a component of the order fulfillment engine 306) may identify locations, also termed “positions” or “slots” in which promoted content may be placed for display to the user. The individual slots may have different sizes, shapes, and other characteristics that may vary in different implementations.

An auction may be performed for each slot, in which the different types of slots and/or characteristics may represent different types of auctions for different circumstances in which the selected content will appear. For example, when a user searches for an item by entering a search query, the terms in the search query may be used as keywords for a keyword auction, in which keywords may be used to determine relevant content campaigns. Similarly, when a user navigates to a page for a particular product, a slot on the product page may be filled by a product auction in which the particular product is used to determine relevant content campaigns. As another example, when a user navigates to a page describing a category of products, a category auction may be used in which the category is used to determine the relevant content campaigns. As such, each of these circumstances may represent a different type or modality for the circumstance in which the winning content of the auction will be presented.

The information used by a campaign manager for determining whether to participate is referred to as an “auction context.” The auction context may indicate at least an auction type (e.g., this auction relates to a keyword search for “milk”) and may include additional characteristics describing the auction opportunity. The auction context generally describes additional contextual information that may be used to evaluate a content campaign's participation in a particular auction. In addition to the auction type and relevant information about the auction type (e.g., describing the search query or the item page viewed by a user), auction context may also describe, for example, the size and position of the slot, other content presented near the slot (e.g., the contents of the search results or other items appearing nearby), information about the user's cart (e.g., other items currently being considered for purchase with this order), user characteristics (e.g., a user's historical orders or an embedding describing the user), and any other contextual information (e.g., time of day, etc.).

In some circumstances, although referred to as different “auction types” as generally separate or orthogonal circumstances (e.g., targeted by separate sub-campaigns as discussed below), in some embodiments the auction context may include information related to multiple auction types. For example, a user may perform an item search and also select a specific category for the search, such as selecting a “snacks” category and then entering a search query for “corn chips.” In this example, the auction context may indicate an auction type for the category (“snacks”) in addition to an auction type for the search keywords (“corn chips”).

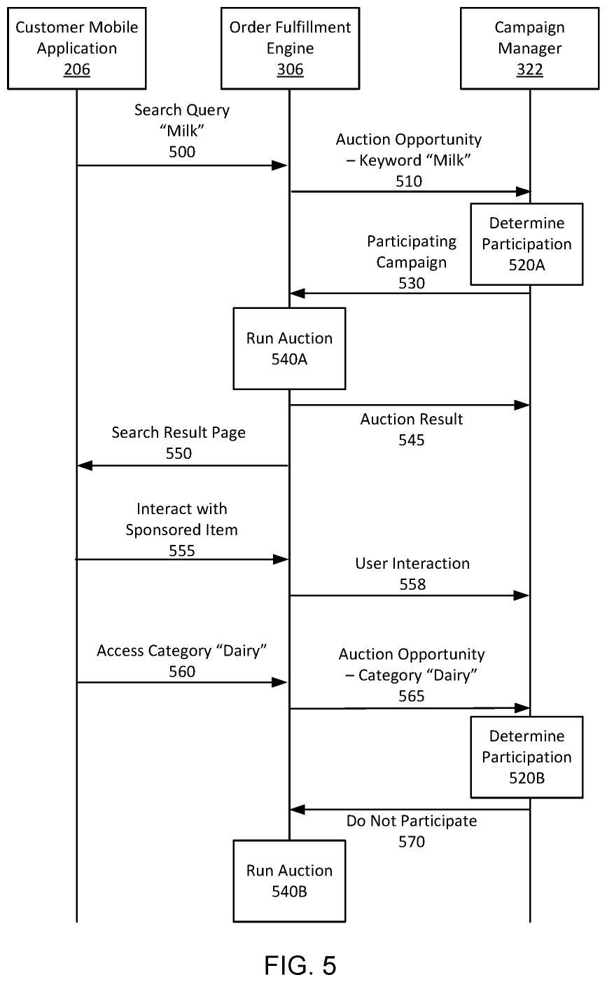

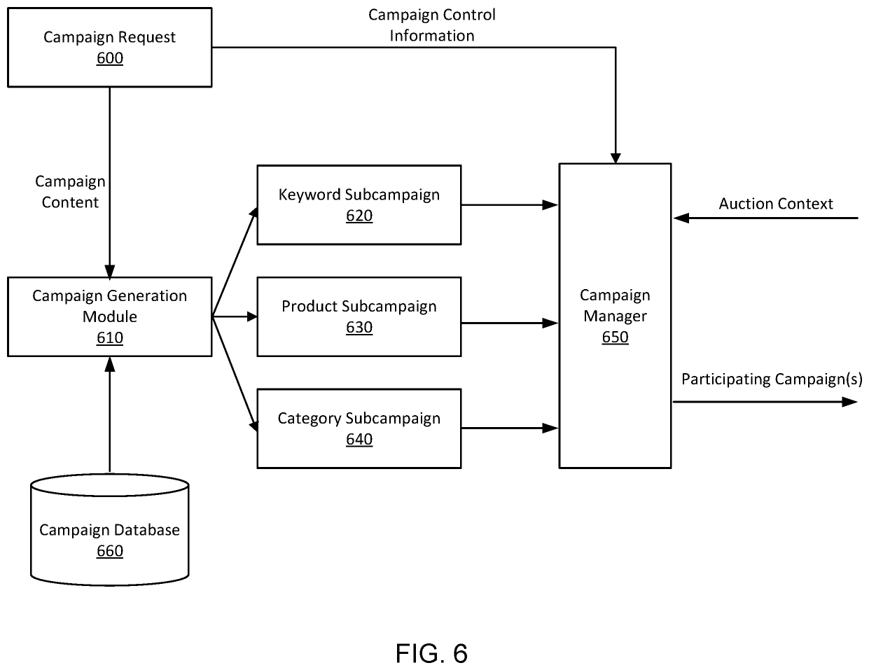

In various embodiments, each content campaign may include a plurality of sub-campaigns that may be used for different auction types (e.g., for placement in different types of slots with different characteristics). For example, a content campaign may include a keyword-based sub-campaign (competing in auctions based on keywords), a product-based sub-campaign (competing in auctions based on products), and a category-based sub-campaign (competing in auctions based on categories). To coordinate campaign budgets between the different sub-campaigns, a campaign manager 322 may monitor the performance of the content campaign and the respective sub-campaigns and control auction participation by the different sub-campaigns. The campaign manager 322 may manage the respective sub-campaigns by modifying respective budgets, holdout rates, and/or bids to dynamically modify auction participation over the course of the content campaign with an aim to optimize a target objective based on the remaining budget and performance of the campaigns. The campaign manager 322 is further discussed with respect to FIGS. 5 and 6 below.

In addition, in some embodiments the online concierge system 102 includes a campaign generation module 326 that assists a sponsor in the creation of a plurality of sub-campaigns for a content campaign. In many circumstances, selecting parameters for individual sub-campaigns may be a complex task for a sponsor; while the additional context of particular auction types may provide an increased ability to determine the circumstances in which the campaign's content is provided to promote the promoted item, it may introduce complexity of requiring a sponsor to determine particular parameters for each type (e.g., the particular keywords, categories, or products relevant to the campaign). As further discussed with respect to FIG. 6, the campaign generation module 326 may automatically generate such parameters for initiating a plurality of sub-campaigns.

Finally, the content campaigns, execution of auctions, management of campaigns, etc., may be implemented in different configurations and by different systems than as shown in FIG. 3. For example, in some embodiments the content campaign database 324, campaign manager 322, and campaign generation module 326 may be implemented by separate systems from the online concierge system 102, such as a third-party system 130. In these circumstances, the online concierge system 102 may provide information describing the available auction slot to the third-party system 130, which may determine content campaigns competing in the auction, execute the auction, and provide the promoted content of a winning campaign to the online concierge system 102 in response.

### Customer Mobile Application

FIG. 4A is a diagram of the customer mobile application (CMA) 206, according to one or more embodiments. The CMA 206 includes an ordering interface 402, which provides an interactive interface with which the user 204 can browse through and select products and place an order. The CMA 206 also includes a system communication interface 404 which, among other functions, receives inventory information from the online shopping concierge system 102 and transmits order information to the system 102. The CMA 206 also includes a preferences management interface 406 which allows the user 204 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 208 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one or more embodiments, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Sub-Campaign Management

FIG. 5 is a timing diagram for providing sponsored content to a user with sub-campaign management, according to one or more embodiments. FIG. 5 shows example interactions between a customer mobile application 206 (e.g., operated by a user), an order fulfillment engine 306, and a campaign manager 322, according to one or more embodiments. The particular components and systems implementing functions of the components shown in this example may also differ in different embodiments. As a general overview, as a user interacts with a customer mobile application 206, the customer mobile application 206 may send requests to the order fulfillment engine 306 to provide information for the user interface. During this process, the order fulfillment engine 306 may determine available opportunities for presenting promoted content and provide opportunities for the campaign manager 322 to determine whether to participate in the auction.

As a first interaction in this example, the user may enter a search query of “milk” in the user interface at the customer mobile application 206, and the customer mobile application 206 sends 500 the search query for “milk” to the order fulfillment engine. The order fulfillment engine 306 may then execute the search and identify a location in which promoted content may be placed. The order fulfillment engine 306 assembles information for the auction context that may be used for the content campaigns to determine whether to participate in the auction opportunity as also discussed above. For example, in addition to the keyword “milk,” the auction context may include the size and position of the slot, other content appearing near the slot (e.g., search results for the keyword search), information about a user's cart, and so forth.

The auction context for the auction opportunity is sent 510 to the campaign manager 322, which determines whether a particular content campaign (and as discussed below, particular sub-campaigns) will participate 520A in the auction opportunity. The discussion of FIGS. 5 and 6 show an example related to a single content campaign; in practice, the campaign manager 322 may make determinations for a large number of different content campaigns, determining, for example, whether each campaign will participate. The participation decision 520 of each content campaign may be independently determined for each of the content campaigns.

For a given content campaign, the campaign manager 322 determines whether any sub-campaign will participate, and if so, with what bid value. Details of the participation decision 520 by the campaign manager 322 is discussed in detail in FIG. 6. When a campaign participates (e.g., a particular sub-campaign participates), information about the participating campaign is sent 530 to the order fulfillment engine 306 along with the relevant information for the auction (e.g., a bid value). The order fulfillment engine 306 may run an auction 540A to determine which content campaign indicated the highest value for the auction opportunity (e.g., as a bid) and may send 545 the auction result to the campaign manager 322 indicating which campaign will have its content presented and what cost is paid by the campaign for winning the auction. The campaign manager 322 may then use the cost paid to reduce the remaining budget for the content campaign as a whole and for the sub-campaign.

After determining the auction result, the relevant content for the user's request (in this case, a search result page) is sent 550 to the customer mobile application 206 along with the relevant content for the campaign that won the auction. The user may further interact 558 with the search result page and/or the content for the campaign to indicate a desired action for the content item. Different content campaigns may prioritize different types of actions as further discussed below. In this example, the user interacts with the sponsored item for the campaign (e.g., clicking on the content), and an indication of the interaction is sent 555 to the order fulfillment engine 306 and/or the campaign manager 322. The campaign manager 322 may monitor the different interactions with respect to selected objectives of the content campaign to determine when different sub-campaigns will participate as further discussed with respect to FIG. 6. In general, the campaign manager 322 may increase the budget allocated to sub-campaigns that yield target objectives more frequently than other sub-campaigns.

FIG. 5 shows another example of another auction opportunity related to a category auction. The user may select a category of “diary” to view products related to that category. The customer mobile application 206 sends 560 the request to access the “diary” category to the order fulfillment engine 306, which similarly sends 565 the auction opportunity to the campaign manager 322 indicating the available auction opportunity for the category “diary.” In this example, the campaign manager 322 determines participation 520B resulting in no participation, which is sent 570 to the order fulfillment engine 306 indicating that the campaign is not participating. The order fulfillment engine 306 may then proceed to run another auction 540B with the participating content campaigns.

FIG. 6 is a block diagram showing dynamic management of sub-campaigns of a content campaign, according to one or more embodiments. FIG. 6 shows an example in which the online concierge system (e.g., via the campaign generation module 326 and campaign manager 322 shown in FIG. 3) automatically generates sub-campaigns and manages participation of the sub-campaigns in auction opportunities. In further examples, these components may be implemented differently or in different systems than what is shown. In this example, a sponsor of the campaign may interact with the online concierge system to provide a campaign request 600 describing information about the content campaign, including campaign content and campaign control information. Though shown here as a single campaign request 600, the sponsor may interact with one or more user interfaces to provide relevant information about initiating and managing the campaign and its sub-campaigns. The campaign content includes information that may be used for the content of the sub-campaigns, such as the specific content to be provided when a sub-campaign successfully wins an auction, the target item promoted by the campaign (e.g., an identifier of the target item, a reference or link to the target item, etc.), and so forth. The campaign control information includes information that may be used by the campaign manager 650 for controlling presentation of the sub-campaigns, such as the total available budget for the campaign, duration of the campaign, and one or more objectives to be optimized for the campaign.

In some embodiments, the campaign generation module 610 generates parameters for individual sub-campaigns. The particular individual sub-campaigns for the campaign may be automatically determined by the campaign generation module 610 or may be designated by the sponsor as part of the campaign request. For example, the campaign request 600 may indicate for the sub-campaigns to include a keyword, product, and category sub-campaign. The sub-campaign parameters may be used to describe, for example, eligibility conditions indicating in what auction contexts the sub-campaign is eligible to participate and a bid amount. In some embodiments, the sub-campaigns may include different sets of eligibility conditions that may each be associated with different bid amounts. For example, a keyword sub-campaign may have eligibility criteria using one keyword with one bid amount, and another keyword using another bid amount. In this example, the campaign generation module 610 creates parameters for a keyword sub-campaign 620, a product sub-campaign 630, and a category sub-campaign 640. The various types of sub-campaigns and auction types may differ for different campaigns and in different embodiments.

Eligibility conditions for the respective auction types may differ for the different auction types and may be particular to each auction type. For example, eligibility conditions for a keyword sub-campaign relating to a keyword auction indicates one or more keywords, while the eligibility conditions for a product sub-campaign relating to a product auction indicates one or more products, etc. For example, for a campaign request for a target item of a brand of ice cream, eligibility conditions for the keyword sub-campaign 620 may include keywords “frozen,” “ice cream,” “frozen yogurt,” and “popsicle,” such that a keyword auction having one of these keywords is eligible for the keyword sub-campaign to offer a bid. Similarly, the product sub-campaign may include one or more products (e.g., individual items) as eligibility conditions, such as a cake, whipped cream, or another ice cream item, such that an auction type of a user viewing one of these product pages is eligible for the product sub-campaign. The category sub-campaign may likewise indicate one or more categories as parameters to be matched with an auction context for the category sub-campaign. The eligibility conditions may also include additional conditions unrelated to the auction type, such as any additional characteristic of the auction context (e.g., other items in a user's cart, or other elements on the page that are being presented to the user).

The particular parameters for each sub-campaign may be provided by the sponsor or may be generated by the campaign generation module, or a combination of these. When the parameters are generated by the campaign generation module 610, the generated parameters may be sent for approval by the sponsor before being used in the campaign.

To automatically generate the sub-campaign parameters, the campaign generation module 610 may use information from the campaign request 600 along with information from a campaign database 660 (e.g., historical performance of campaigns) to determine parameters that may be effective for each sub-campaign.

The bids for each sub-campaign may be automatically generated by the campaign generation module 610 based on one or more objectives from the sponsor. Higher bid amounts may mean that the sub-campaign more often wins an auction but at the expense of drawing down the budget more quickly. If a bid amount is too low, the sub-campaign may no longer successfully win auctions of its type. As such, the bid amount may automatically be set, for each sub-campaign, at a level that permits the sub-campaign to win that auction type. The bid amount may be based on historical bid amounts by the sponsor, e.g., based on previous campaigns of the sponsor. In addition, the bid amount may be set based on average bid amounts at which the auction type (e.g., a keyword auction) clears (e.g., amounts actually paid when that auction type is completed). The bid amounts in some embodiments may also be modified during execution of the campaign as discussed below to increase or decrease the frequency that the sub-campaign successfully wins the auction, and thus also affects the spending rate of the sub-campaign.

The objectives of the sponsor may also be used to determine the bid amount. In particular, a ratio of the bid (expected spending rate or other price paid) relative to a value or frequency of the objective may be determined. The ratio may also be expressed as the objective relative to the bid/value paid. The ratio thus indicates a return of the spending/bid relative to the objective. The bid (and/or expected spending rate or other price paid) may be prevented from exceeding a value that would indicate an insufficient yield ratio below a threshold. The insufficient yield may be expressed as a threshold, such that insufficient return on the objective reduces the bid amount. This may prevent the sub-campaigns from bidding highly to win auctions for which there is insufficient benefit. The objectives in some embodiments may be the presentation of the content to a user (i.e., an impression). In these examples, the objective may occur each time the sub-campaign wins an auction. In other examples, the objective may be related to further actions performed by users after the user is presented with promoted content. For example, a user interaction with the promoted content (e.g., clicking the content to view further information or a link to another page), the user viewing a promoted item, the user adding the promoted item to a cart, etc. For these actions, winning the auction may not itself define success relative to the objective, and these actions may vary in how often they occur after participating in or winning an auction.

The campaign generation module 610 may use prior campaigns for the item, sponsor, or similar campaigns to the current campaign item to estimate a frequency of the objective based on winning the auction, such that the estimated frequency can be evaluated to determine the ratio for the bid. The estimated frequency may also be combined with a value of the objective to determine an expected value for the sub-campaign when it wins an auction. The bids may thus be automatically set and the ratio may be used to prevent the bid value from exceeding a value that would ineffectively spend the budget relative to the campaign objective. As noted above, the bids may be separately determined for different eligibility criteria of the sub-campaigns. This may be because each set of eligibility criteria may yield different results with respect to the objective (e.g., different interaction rates for the desired action). For example, each keyword (or a group of keywords) in the keyword sub-campaign 620 may be associated with different bid amounts-a keyword that has higher interaction rates may have a higher bid amount than another keyword with relatively lower interaction rates, while each having a similar ratio.

In addition to the bid amount for a sub-campaign, the campaign generation module 610 may also determine parameters for the eligibility conditions for the sub-campaigns. In some embodiments, the eligibility conditions for each sub-campaign are determined first, and then the respective bids for each sub-campaign (or separate eligibility criteria within a sub-campaign) are determined. The campaign generation module 610 may thus generate a set of keywords for the keyword sub-campaign 620, products for the product sub-campaign 630, and categories for the category sub-campaign 640 that describe when the sub-campaigns may be eligible to participate in an auction opportunity. The eligibility conditions may be based on information in the campaign request 600 along with information from prior campaigns and other relevant information relating different concepts, products, and terms, from the campaign database 660.

The keywords for the keyword sub-campaign 620 may be automatically generated based, e.g., on the promoted item for the content campaign along with a description of the item and any additional keywords provided by the sponsor. The keywords may be based on word embeddings of the target item based on historical search terms in which users select the target item as a result, descriptions of co-purchased items, and so forth. In one or more embodiments, the keywords are based on a set of seed keywords (e.g., from the sponsor or the item description) and user engagement metrics, for example as discussed in U.S. patent application Ser. No. 17/899,441, filed Aug. 30, 2022, the contents of which are hereby incorporated by reference.

Similarly, the products for the product sub-campaign 630 may be automatically generated based, e.g., on the promoted item for the content campaign and other similar, complementary, or co-related items. The products may be determined, for example, based on items co-added to a user's cart, items selected as substitutes for other items, similarity of item descriptions (e.g., based on word embeddings of the respective descriptions), other items on a page associated with the target item, and so forth. The sponsor may also provide products for the product campaign or excluded products that may not be included in the product sub-campaign.

To generate categories for the category sub-campaign 640, the campaign generation module 610 may identify one or more categories of the target item and select categories for the category sub-campaign 640 that are related to the identified categories. The related categories may be determined, for example, by categories on an adjacent taxonomy branch as the category of the item, or categories at a higher (more general) level than the category of the item, among other approaches. The categories for an item may also be determined based on categories used for historical campaigns in the campaign database 660 for the item or similar items (e.g., as may be determined for the product sub-campaign 630).

After determining the parameters of the sub-campaigns and optional approval by the sponsor, the sub-campaigns may be added to the set of campaigns that may participate in an auction opportunity. The campaign manager 650 operates as an intermediate layer between the sub-campaigns and participation in auction opportunities. In particular, the campaign manager 650 may optimize participation of the sub-campaigns over time to maximize the campaign objectives by modifying the budget used by the respective sub-campaigns over time. In some embodiments, the campaign manager 650 may modify a set of parameters for the sub-campaigns that are automatically applied to affect auction participation, and in other embodiments the campaign manager 650 may determine whether to participate for a sub-campaign as individual auction opportunities are received. The parameters for participating in auction opportunities may include a sub-campaign budget, a holdout rate (e.g., a portion of the eligible auction opportunities that the sub-campaign does not participate in), or adjusting the bid for the sub-campaign.

In general, optimized participation by the sub-campaigns is difficult to optimize, not only because the different sub-campaigns may successfully achieve the campaign objectives at different rates, but also because they may do so at different rates in different auction contexts. Each auction opportunity may arise unpredictably and may do so at different frequencies for different auction types (which correspond to opportunities for different sub-campaigns). In addition, a sponsor may also have a goal of using the overall campaign budget within a time period for the campaign, such as within a day or week. Even where one sub-campaign performs most effectively at achieving the objective in one context or at one point in time, it may not be effective to solely allocate budget to that sub-campaign as there may be a limited number of available auction opportunities of that type. In addition, the actual extent to which each sub-campaign may achieve the objectives may be unknown and may vary with time. Hence, allocating budget solely to one sub-campaign may limit the feedback received with respect to other campaigns, preventing the exploration of whether other sub-campaigns perform more effectively (or the preferred sub-campaign less effectively).

To address these problems, the campaign manager uses a reinforcement learning model to affect participation of the sub-campaigns. The reinforcement learning model uses a current context to determine a next action based on the expected rewards of the possible actions. In one or more embodiments, the reinforcement learning model is a “multi-armed bandit” model, in which the different sub-campaigns have associated costs and rewards, where the rewards for a particular action are inconsistent and may change over time. Other types of reinforcement learning model architectures may also be used that account for the changing context of the campaign over time and may adjust auction participation and other parameters.

In the reinforcement learning model, the possible output “action” affects (or itself directly controls) the participation of the sub-campaigns in auction opportunities. For example, in one or more embodiments, the determined “action” of the reinforcement learning model is to set parameters of each sub-campaign for participating in auctions (e.g., a sub-campaign budget, holdout rate, bid amount, etc.,) that thus affect the budget spending rate of the sub-campaign. These parameters may be set for a time interval, after which the model may be re-run to set parameters for the next time interval. For example, for a campaign manager managing a budget allocated for a day, the campaign manager may execute the reinforcement learning model to set parameters for each hour. Thus, when the campaign is initiated, the reinforcement learning model may set initial parameters for the first hour. After the first hour the reinforcement learning model may set parameters for the second hour, and so forth.

In other embodiments, the campaign manager may use the “action” to determine whether to participate in individual auction opportunities that arrive for each sub-campaign. In these embodiments, when an auction context for an auction opportunity is received, the campaign manager uses the reinforcement learning model to determine whether a particular sub-campaign will participate in the auction opportunity. This may also be considered as a situation in which the “interval” for re-running the reinforcement learning model is set to zero (i.e., is run to determine parameters “on-demand” responsive to the received auction opportunity), such that the actions (or parameters) for determining whether a sub-campaign participates may be determined for each auction opportunity. In one or more embodiments, rather than directly outputting a decision of do/do not participate, the campaign manager outputs the parameters, such as a holdout rate, which is evaluated with respect to the current opportunity to determine whether a sub-campaign participates. As such, the output of the reinforcement learning model in some embodiments is a set of parameters describing a “strategy” that may be implemented for the current auction opportunity.

To evaluate current circumstances and determine the effect of actions in those circumstances, the reinforcement learning model may also receive (or determine) a current context and a set of expected rewards associated with the actions. The context may describe current conditions used for determining the relevant environment for the action, which may include a state of the campaign, such as a current spend rate of the campaign, remaining budget for the campaign, remaining time for the budget, and so forth, as well as a description of the auction environment, such as a time of day, a day of the month, day of the week, season (e.g., spring, summer, fall, etc.), and other characteristics of the general auction environment. In circumstances in which the reinforcement learning model is applied to evaluate individual auction opportunities, the auction context may also be included as an input. As discussed above, the auction context may include, e.g., other elements on a page, contents of a user's cart, and so forth.

Finally, the reinforcement learning model may associate “rewards” with each action and optimize the actions to maximize rewards. The rewards evaluated to select an action may be customizable and defined based on the objectives of the sponsor. The objectives may include the objectives discussed above and may include a combination or prioritization of objectives. For example, the objectives may include maximizing a rate of user interaction with the content and using the campaign budget within the campaign time period. In general, the objectives may aim to maximize the ratio of objectives to cost (or said differently, minimize cost per objective) over the duration of the campaign. As sub-campaigns participate in auction opportunities, the cost and achieved objectives may then be converted to a “reward” associated with the output action of the campaign participating.

As sub-campaigns participate in auctions, information about the cost of the action and objectives are thus received by the campaign manager to inform the reinforcement learning model. As different sub-campaigns perform relatively well or poorly with respect to the objectives and at different costs, the campaign manager may thus automatically adjust the perceived rewards for different actions in different contexts, and thus modify participation of the sub-campaigns to optimize the objectives over the course of the campaign.

The campaign manager may initially assess rewards based on historical campaign data (e.g., suggesting a high return on cost for a keyword campaign and relatively lower return on cost for a product sub-campaign) to set initial parameters for the sub-campaigns. In other embodiments, the sub-campaigns may be initially set to evenly participate or use campaign budget (e.g., to split the budget evenly). As auctions appear and the sub-campaigns participate, additional information is received with respect to the cost and rewards of each sub-campaign, such that the campaign manager may automatically adjust the allocation among the sub-campaigns and re-evaluate effectiveness of each. At a first point in time (e.g., at the initial campaign creation), the reinforcement learning model may have a context describing the current time of day, campaign spend, available campaign, etc., along with expected costs and rewards of each action related to each sub-campaign. As time passes, auction results may be determined for each sub-campaign, such that when the reinforcement learning model is applied at another time, the changed context may include both the different context (e.g., a later time of day, the amount of budget remaining, amount of time remaining, etc.) and a different estimate of the relevant rewards for each sub-campaign (e.g., the cost and success rate for the particular objective).

In some embodiments, the reinforcement learning model also learns a relationship between the context and the expected reward for an action, such that the input context affects the expected reward for the sub-campaign participation. The relationship between the context and the reward may be learned during operation of the reinforcement learning model for a particular campaign and may be based on data from historical campaigns in the database, such as those related to the sponsor, promoted item, etc., The context may indicate, for example, a particular season or time of day or auction context that may affect the extent to which different sub-campaigns product objectives (e.g., it may be that in the morning, the category sub-campaign generally has elevated objective rates, while in the evening, the keyword sub-campaign generally has elevated objective rates). As such, the allocation of auction participation (e.g., budget or spending rate) to these sub-campaigns may be changed at different times of day to optimize for this changing context.

As another example, the spending rate and remaining budget may also be used to adjust participation by the sub-campaigns. Consider one sub-campaign that, in a particular context, outperforms other sub-campaigns with respect to received objectives per cost. However, there may be a limit to the number of auctions that the sub-campaign may participate in, such that the sub-campaign is already using an action that maximizes the participation by that sub-campaign. For example, a highly relevant keyword related to an item may be effective for a keyword sub-campaign, but may infrequently appear, such that the total spend rate is low. As such, the overall spending rate may nonetheless be lower than a rate that achieves an objective of using the budget within the campaign period. In this context, to achieve the objective of using the overall campaign budget, the reinforcement learning model may allocate additional participation by other sub-campaigns to increase the overall spending rate and increase progress towards the objective of the overall spending rate. In some embodiments, the objective-to-cost return (i.e., ratio) is also used as a threshold to prevent actions that would ineffectively use the budget. For example, the objective of using the budget within the particular time may not be achieved or prioritized when additional participation by a sub-campaign is expected to provide an objective-to-cost ratio below a threshold.

As such, by using the campaign manager as a layer that monitors and adjusts participation of individual sub-campaigns, campaigns may be initiated with a set of sub-campaigns and automatically adjusted during execution of the campaign based on the changing context and updated information regarding the success of the sub-campaigns. This avoids the need for the sponsor to individually monitor and adjust sub-campaigns and allows the automatic creation and management of the different sub-campaigns for different auction types, thus more effectively achieving the sponsor's objectives.

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying, for a content campaign, a content campaign budget for promoted content related to a promoted item;
identifying a plurality of auction results from auctions that were previously-conducted for a plurality of sub-campaigns of the content campaign, each sub-campaign corresponding to a different auction type;
applying a reinforcement learning model to determine an allocation of the content campaign budget to each of the plurality of sub-campaigns based on the plurality of auction results and a target objective;
participating in one or more auction opportunities by one or more sub-campaigns of the plurality of sub-campaigns based on the allocation of the content campaign budget; and
sending, to one or more customer devices, promoted content associated with campaigns that won the auction opportunities.

2. The method of claim 1, wherein participating in auction opportunities comprises setting a holdout rate of each of the plurality of sub-campaigns based on the respective allocated budget.

3. The method of claim 1, wherein the reinforcement learning model determines the allocation based on a context for the allocation, including one or more of: a current spend rate, remaining budget for the content campaign budget, remaining time for the content campaign budget, and a current season.

4. The method of claim 1, further comprising:
determining a bid for auction opportunities by at least one or more of the plurality of sub-campaigns based on a minimum ratio of the bid to an expected value of the target objective for the one or more of the plurality of sub-campaigns.

5. The method of claim 1, further comprising:
determining additional auction results after participating in auction opportunities for an amount of time; and
applying the reinforcement learning model to modify the allocation based on the additional auction results.

6. The method of claim 1, wherein participating in the auction opportunities includes determining whether to participate in an individual auction opportunity by a sub-campaign based on characteristics of the individual auction opportunity, including one or more of: a user, other content presented on a page, and information describing a user's cart.

7. The method of claim 1, wherein the target objective is one or more of: a ratio of an objective-to-cost, interactions with the promoted content, interactions with the promoted content, and user views of the promoted content.

8. A computer program product comprising a non-transitory computer readable medium having instructions encoded thereon that, when executed by a processor, cause the processor to perform steps comprising:
identifying, for a content campaign, a content campaign budget for promoted content related to a promoted item;
identifying a plurality of auction results from auctions that were previously-conducted for a plurality of sub-campaigns of the content campaign, each sub-campaign corresponding to a different auction type;
applying a reinforcement learning model to determine an allocation of the content campaign budget to each of the plurality of sub-campaigns based on the plurality of auction results and a target objective;
participating in one or more auction opportunities by one or more sub-campaigns of the plurality of sub-campaigns based on the allocation of the content campaign budget; and
sending, to one or more customer devices, promoted content associated with campaigns that won the auction opportunities.

9. The non-transitory computer readable medium of claim 8, wherein participating in auction opportunities comprises setting a holdout rate of each of the plurality of sub-campaigns based on the respective allocated budget.

10. The non-transitory computer readable medium of claim 8, wherein the reinforcement learning model determines the allocation based on a context for the allocation, including one or more of: a current spend rate, remaining budget for the content campaign budget, remaining time for the content campaign budget, and a current season.

11. The non-transitory computer readable medium of claim 8, the instructions further causing the processor to perform steps comprising:
determining a bid for auction opportunities by at least one or more of the plurality of sub-campaigns based on a minimum ratio of the bid to an expected value of the target objective for the one or more of the plurality of sub-campaigns.

12. The non-transitory computer readable medium of claim 8, the instructions further causing the processor to perform steps comprising:
determining additional auction results after participating in auction opportunities for an amount of time; and
applying the reinforcement learning model to modify the allocation based on the additional auction results.

13. The non-transitory computer readable medium of claim 8, wherein participating in the auction opportunities includes determining whether to participate in an individual auction opportunity by a sub-campaign based on characteristics of the individual auction opportunity, including one or more of: a user, other content presented on a page, and information describing a user's cart.

14. The non-transitory computer readable medium of claim 8, wherein the target objective is one or more of: a ratio of an objective-to-cost, interactions with the promoted content, interactions with the promoted content, and user views of the promoted content.

15. A system comprising:
a processor configured to execute instructions; and
a non-transitory computer readable storage medium having instructions encoded thereon that, when executed by the processor, cause the processor to perform steps comprising:
identifying, for a content campaign, a content campaign budget for promoted content related to a promoted item;
identifying a plurality of auction results from auctions that were previously-conducted for a plurality of sub-campaigns of the content campaign, each sub-campaign corresponding to a different auction type;
applying a reinforcement learning model to determine an allocation of the content campaign budget to each of the plurality of sub-campaigns based on the plurality of auction results and a target objective;
participating in one or more auction opportunities by one or more sub-campaigns of the plurality of sub-campaigns based on the allocation of the content campaign budget; and
sending, to one or more customer devices, promoted content associated with campaigns that won the auction opportunities.

16. The system of claim 15, wherein participating in auction opportunities comprises setting a holdout rate of each of the plurality of sub-campaigns based on the respective allocated budget.

17. The system of claim 15, wherein the reinforcement learning model determines the allocation based on a context for the allocation, including one or more of: a current spend rate, remaining budget for the content campaign budget, remaining time for the content campaign budget, and a current season.

18. The system of claim 15, wherein the instructions are further executable for:
determining a bid for auction opportunities by at least one or more of the plurality of sub-campaigns based on a minimum ratio of the bid to an expected value of the target objective for the one or more of the plurality of sub-campaigns.

19. The system of claim 15, wherein the instructions are further executable for:
determining additional auction results after participating in auction opportunities for an amount of time; and
applying the reinforcement learning model to modify the allocation based on the additional auction results.

20. The system of claim 15, wherein participating in the auction opportunities includes determining whether to participate in an individual auction opportunity by a sub-campaign based on characteristics of the individual auction opportunity, including one or more of: a user, other content presented on a page, and information describing a user's cart.
